(19) United States
(12) Patent Application Publication
(10) Pub. No.: US 2015/0172787 A1
(43) Pub. Date: Jun. 18, 2015

(54) CUSTOMIZED MOVIE TRAILERS

(71) Applicant: Alborz Geramifard, Cambridge, MA (US)

(72) Inventor: Alborz Geramifard, Cambridge, MA (US)

(73) Assignee: Amazon Technologies, Inc., Reno, NV (US)

(21) Appl. No.: 14/105,428

(22) Filed: Dec. 13, 2013

(51) Int. Cl. H04N 21/8549; H04N 21/4722; H04N 21/482

(52) U.S. Cl. CPC H04N 21/8549; H04N 21/482; H04N 21/4722

(57) ABSTRACT

A content delivery system, such as an on-demand movie catalog, is configured to customize previews of content based on previously determined user preferences and metadata associated with the content. A user may select a particular item of content, such as a movie, and the system will dynamically create a short preview of the movie including portions of the movie that are likely to appeal to the user, such as scenes featuring certain actors, themes, locales, etc. The selection of scenes is compiled by cross-referencing the user preferences with metadata and other information associated with the movie and the content of specific scenes. The preview may also be compiled using components and methods configured to create a preview that both includes content desirable to the viewing user, but also content that can be combined to create a logical preview.

### BACKGROUND

With the advancement of technology, a wide variety of digital content is now available for users to view on-demand. At any particular time, users may choose between thousands of different movies, television programs, or other multimedia content. A user may browse a content catalog, select a program, and then view the program on a user device, often while the content of the program is streamed from a remote location.

### BRIEF DESCRIPTION OF DRAWINGS

For a more complete understanding of the present disclosure, reference is now made to the following description taken in conjunction with the accompanying drawings.

FIG. 1 illustrates a system overview for creating customized program previews according to one aspect of the present disclosure.

FIG. 2 is a block diagram conceptually illustrating a computing device according to aspects of the present disclosure.

FIG. 3 illustrates a computing network for use with distributed processing according to aspects of the present disclosure.

FIG. 4 illustrates an example of a table of program feature metadata according to one aspect of the present disclosure.

FIG. 5 illustrates an example of a table of user profiles and user preference data according to one aspect of the present disclosure.

FIG. 6 illustrates a method for creating customized program previews according to one aspect of the present disclosure.

### DETAILED DESCRIPTION

Video-on-demand has become a popular method of delivering content to users. Films, television shows, and other types of programs can be stored on a large server or group of servers and delivered to multiple users over the Internet. Such on-demand systems may have thousands of titles to choose from, so many that an individual user may be overwhelmed with choices. To assist a user in selecting a title to purchase or rent, a system may invite a user to view a preview of the program. Movie and television previews are often created by the same creators as the program, such as a movie or television studio. Such previews, also called trailers, are typically designed to appeal to the largest possible audience, or to a particular demographic the studio believes will most wish to see the program. Sometimes several versions of a trailer may be available, but these are often variations of the original trailer and usually follow a typical “one-size-fits-all” approach when attempting to gather interest from potential viewers for the showcased program.

Offered is a system and method to dynamically create customized trailers or previews that match the content of the full program with a user's previously demonstrated interests. A customized trailer may be more likely to display to the user content from the program that is of interest to the user, thus increasing the likelihood that the user selects the program in question for viewing as well as increasing the likelihood that the user is ultimately satisfied with his or her selection. Using the present system a user may select a program, such as by scrolling over a picture of a movie poster on a website, and a trailer customized based on the user's preferences may be dynamically created and displayed to the user. As used herein the term “program” includes a movie, film, television show, short, online video, or other multimedia content that may be viewed by a user.

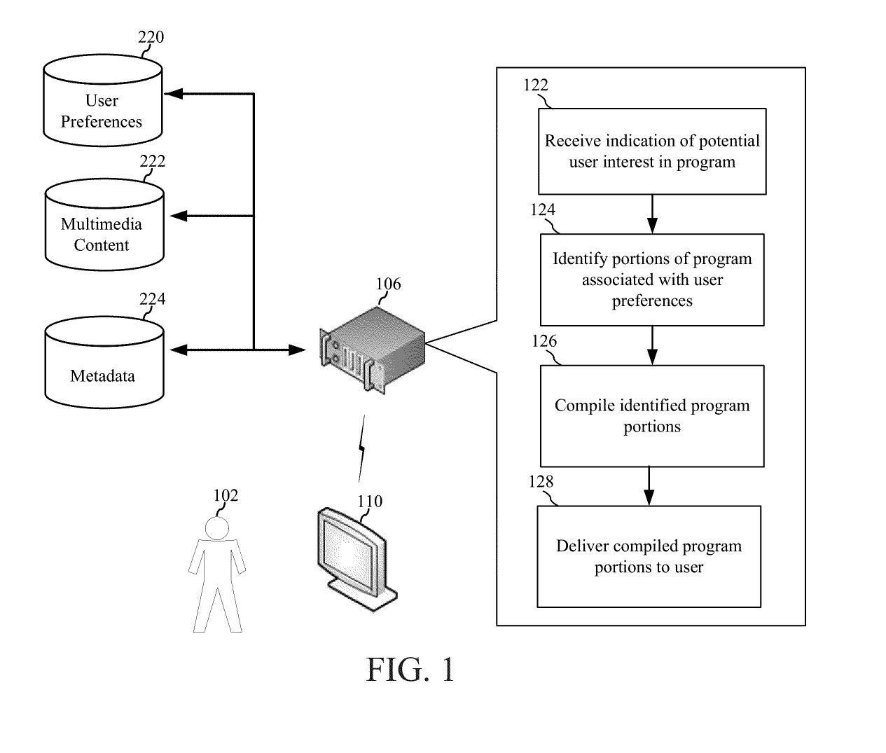

FIG. 1 illustrates a system for creating customized previews. A user 102 interacts through his/her home computer or device 110 to browse multimedia programming options available from a server 106. In FIG. 1, the program options are stored in multimedia content storage 222 which is in communication with the server 106. If the user 102 desires to learn more about a particular program, he/she sends an indication to the server 106. This indication may take many forms, such as expressly requesting information about the program, going to a page associated with the program, moving a cursor over an particular location associated with the program, clicking a specified link, etc. The server 106 then receives the indication of the user's interest in the program, as shown in block 122.

After receipt of the indication of the user's interest in the program, the server 106 then queries a library of user content preferences 220 to determine what program features are preferred by the particular user 102. The preferences of the user 102 may be stored in a user profile. As explained below, examples of program features that may be preferred by the user include specific actors, characters, directors, themes, age-appropriate content, ratings, or the like. The server 106 then queries a metadata library 224 for metadata associated with the particular program the user is interested in. The metadata may include information about what features are associated with the program, and in particular, what features are in what scenes of the program.

The server 106 then cross references the user preferences with the program metadata to identify what portions of the program are associated with the user preferences, as shown in block 124. As an example, if the user likes particular actor, the server 106 may use the metadata to identify scenes in the program featuring that actor. As a further example, if the user has shown an affinity for action scenes, the server 106 may use the metadata to identify action scenes that feature the actor.

Once the server 106 has identified the portions of the program that match the user preferences, the server 106 may retrieve those portions of the program, such as video clips, from the multimedia content storage 222. The server may then, as shown in block 126, compile the retrieved portions into a short preview of the program. The preview will thus include portions of the program that include program features that are preferred by the user. The server 106 may also include other portions of the program in the preview that do not necessarily include user preferred features, as such portions that provide continuity and context to the generated preview (such as credits, portions of important scenes, etc.). The server 106 may then deliver the compiled program portions to the user, as shown in block 128. The compiled portions may be delivered by streaming the preview to the user computer 110, or through other delivery means.

In another aspect, the system may take a previously created program preview and reorder it, using the user preferences and metadata to prominently show portions of the preview that include the user's preferred features.

The following description provides exemplary implementations of the disclosure. Persons having ordinary skill in the field of computers, audio, and mapping technology will recognize components and process steps described herein that may be interchangeable with other components or steps, or combinations of components or steps, and still achieve the benefits and advantages of the present disclosure. Moreover, in the following description, numerous specific details are set forth in order to provide a thorough understanding of the disclosure. It will be apparent to one skilled in the art, however, that the disclosure may be practiced without some or all of these specific details. In other instances, well-known process steps have not been described in detail in order not to unnecessarily obscure the disclosure.

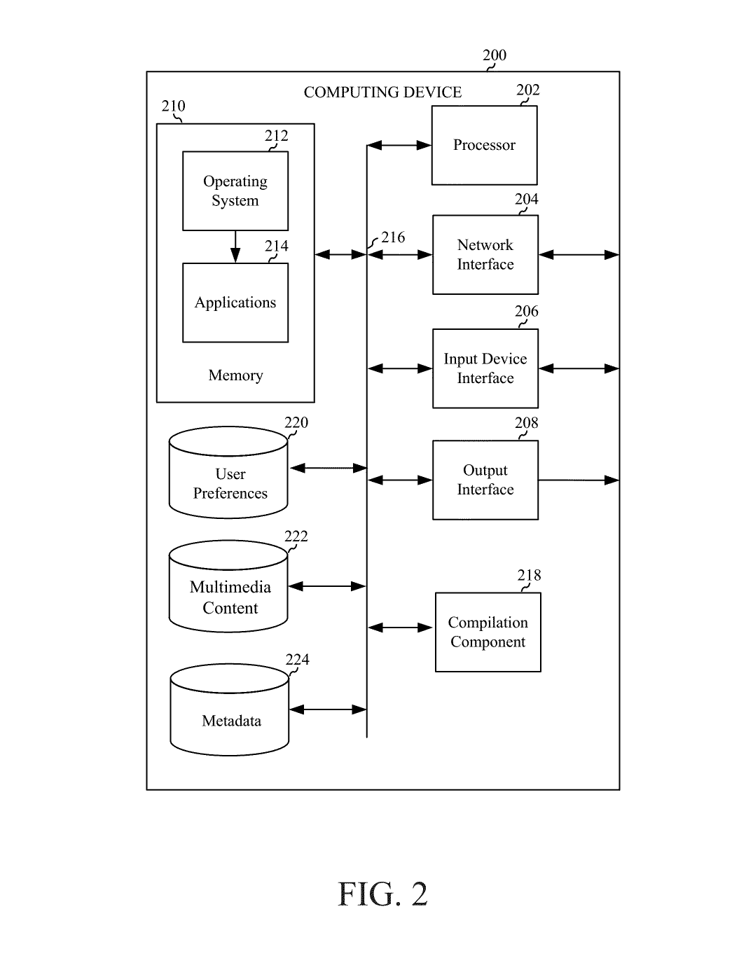

Aspects of the present disclosure may be implemented as a computer implemented method in a computing device or computer system. These computing devices may include, but are not limited to, mobile phones, laptop computers, tablet computers, personal computers, workstations, mini- and mainframe computers, servers, and the like. These computing devices may also include specially configured computers for processing digital multi-media content. The general architecture of a suitable computing device is described below with reference to FIG. 2. More particularly, FIG. 2 is a block diagram illustrating exemplary components of a computing device 200 suitable for creating customized content previews. However, the following description of the exemplary components of a computing device 200 should be viewed as illustrative only and not construed as limiting in any manner.

With regard to FIG. 2, the exemplary computing device 200 may include a processor 202 in communication with a variety of other components over a system bus 216 or through a direct connection. These other components may include, by way of example, a network interface 204, an input device interface 206, an output interface 208, and a memory 210. As appreciated by those skilled in the art, the network interface 204 enables the computing device 200 to communicate data, control messages, data requests, and other information with other resources including computers, data sources, storage devices, and the like, on a computer network such as the Internet. The network interface 204 may be configured to communicate via wired or wireless connections. As one skilled in the art will appreciate, the computing device 200 may obtain and compile user preferences, tag and process multi-media content, compile customized previews and/or display content to a user. The computing device 200 may also communicate with other computing devices to perform any of the processes discussed here.

The input device interface 206, sometimes also embodied as an input/output interface, enables the computing device 200 to obtain data input from a variety of devices including, but not limited to, a microphone, a digital pen, a touch screen, a keyboard, a mouse, a scanner, and the like. In addition to the exemplary components described above, an output interface 208 may be used for outputting information such as audio signals or display information. Display information may be output by the output interface 208 via a display device (e.g., a monitor or similar device, not shown), for example. Audio output may also be output by the output interface 208 to an audio device such as a speaker, for example. Of course, while not shown, one skilled in the art will appreciate that one or more audio output speakers, may be incorporated as an integral element within a computing device 200 or may be separate therefrom.

The processor 202 may be configured to operate in accordance with programming instructions stored in a memory 210. The memory 210 generally comprises RAM, ROM, and/or other memory. Thus, in addition to storage in read/write memory (RAM), programming instructions may also be embodied in read-only format, such as those found in ROM or other permanent memory. The memory 210 may store an operating system 212 for controlling the operation of the computing device 200. The operating system may be a general purpose operating system such as a Microsoft Windows operating system, a UNIX operating system, a Linux operating system, or an operating system specifically written for and tailored to the computing device 200. Similarly, the memory 210 may also store user-executable applications 214, or programs, for conducting various functions on the computing device 200. For example, the application 214 in memory 210 may be configured according to aspects of the present disclosure to select and compile program scenes.

The computing device 200 may also include a compilation component 218 for compiling customized content previews as disclosed herein. The computing device 200 may also include a user preference storage component 220 for storing user preferences as those preferences relate to multimedia content and other preferences/interests of a user. The computing device may also include a multimedia content storage component 222 for storing multi-media content. The computing device may also include a metadata storage component 224 which stores metadata and other cataloging information regarding the multimedia content stored in component 222.

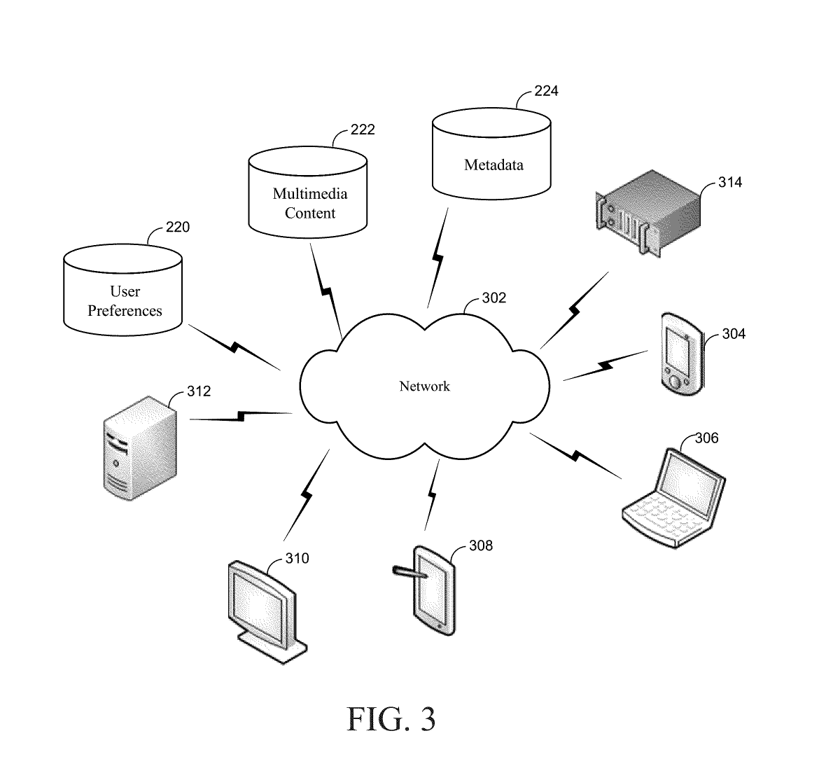

It should also be understood that the following description is presented largely in terms of logic and operations that may be performed by conventional computer components and media components. These computer components, may be grouped in a single location or distributed over a wide area. In circumstances where the computer components are distributed, the components may be accessible to each other via wired and/or wireless communication links, for example. For example, the various storage components 220, 222, and 224 may be located with the computing device 200 or may be located elsewhere and communicatively connected to the computing device 200 over a network, as illustrated in FIGS. 1 and 3. Further, the various storage components may be combined (such as the content and metadata stored together) or distributed, such as with multiple content servers combining to serve the purpose of the multimedia content storage component 222.

As shown in FIG. 3, multiple devices may be connected over a network 302. Network 302 may include a local or private network or may include a wide network such as the internet. Devices may be connected to the network 302 through either wired or wireless connections. For example, a wireless device 304 may be connected to the network 302 through a wireless service provider. Other devices, such as laptop 306 or tablet computer 308 may be capable of connection to the network 302 using various connection methods including through a wireless service provider, over a WiFi connection, or the like. Other devices, such as computer 310, may connect to the network 302 through a wired connection.

In certain system configurations, one or more remote devices may determine and store user preferences, tag and catalog multimedia programs, and dynamically create customized previews. Those previews may then be delivered to a user device for playback to a user. For example, a user may operate a computer 310 or laptop 306 to indicate preferences to a remote computer 312 which stores the user preferences at a different location 220. The user may later connect to a server 314 using a tablet 308 or phone 304 to browse multimedia content stored at location 222. The server 314 may then cross reference metadata 224 and user preferences 220 to create a customized preview for the user and send the preview to the table 308 and/or phone 304 for viewing by the user.

To create customized trailers that are tailored to a specific user's interests, the system may make use of two particular sets of information. The first is a library of metadata in which program content is catalogued in a robust manner for retrieval and analysis by the system. The second is a set of information regarding preferences of individual users. The two may then be cross referenced as described below to create customized previews for users.

The metadata library may include, for example, movies or television shows in which individual scenes are associated with various data points regarding program features such as actors in the scene, characters portrayed by the actors in the scene, scene start and end time, location of scene, content of scene, etc. The metadata may also be broken down extensively, to provide detailed information about the program features. For example, metadata regarding content of a scene may include information about what lines are spoken by what actors, what the setting of the scene is, whether the scene takes place indoors or outdoors, at night or during the day, at what point in the program the scene appears, what audio is detected during the scene (such as background noise, soundtrack, or the like), whether the scene stands alone or is referred to or repeated at other points during the program (or even in a different program, such as a movie sequel), and many other kinds of information. The metadata may also include information that spans programs such as identifying a scene in one program that is similar to another program (either in content, setting, location, etc.), identifying where characters or actors in one program appear in other programs, etc. One example of such a metadata library is the X-Ray™ library and service currently available with the Amazon® Instant Video service and Kindle® devices. X-Ray™ presently offers multiple forms of metadata on programs including information about specific scenes, actors, related programs, etc. Other metadata library forms may also be used.

The metadata library may be compiled in a number of ways, including manual tagging of programs where human operators catalog programs as those programs are viewed. In other aspects the metadata may be created using semi-automated techniques such as automatic speech recognition, speaker recognition, facial recognition and/or other data processing techniques. The results of such processing may be compiled by operators or assembled by machine. Creation of the metadata may also include natural language processing techniques to understand the content of the program or portions thereof. Such content understanding may also be provided by human operators. External information about a program, such as available scripts, commentary on the program and/or specific scenes, or other kinds of information may also be used to tag the program to provide a rich metadata library associated with the program content.

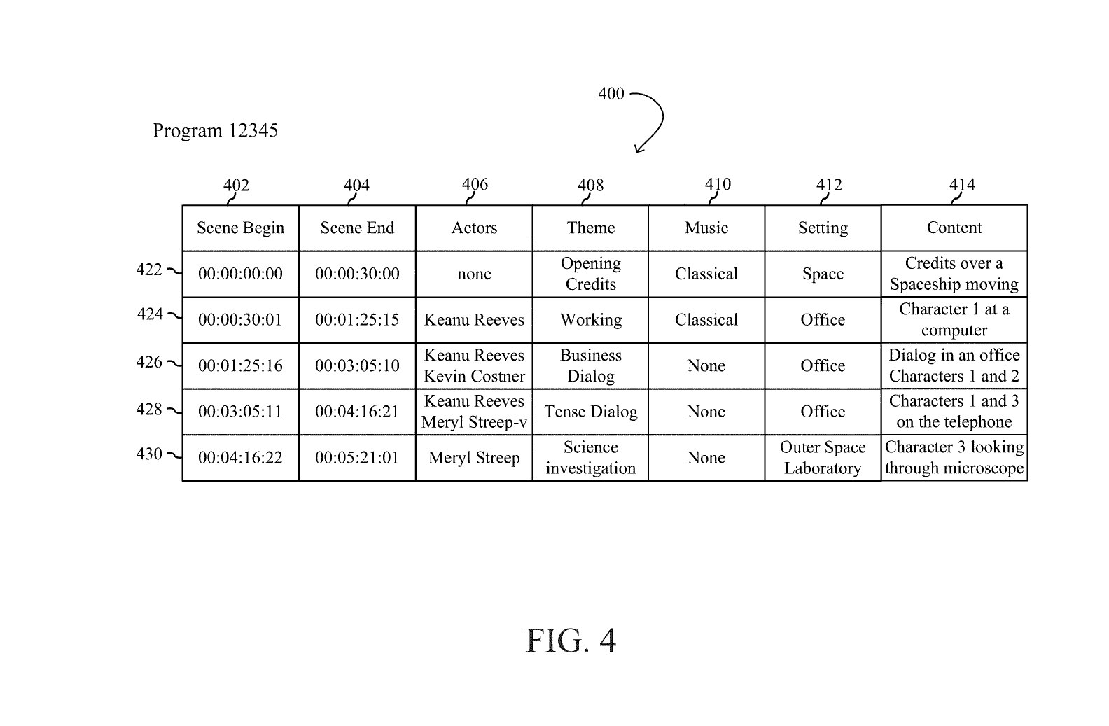

An example of an entry in the metadata library is shown in FIG. 4. FIG. 4 is offered for illustration purposes as the metadata library and its contents may take a variety of forms. FIG. 4 shows a partial table 400 cataloguing the first few scenes (422-430) from a fictional film called Program 12345. The table includes two columns, scene begin 402 and scene end 404, marking the beginning and end of a particular scene and five columns representing different program features associated with the particular scene including actors 406, theme 408, music 410, setting 412, and content 414. The features may themselves be further broken down, as indicated by Meryl Streep appearing in scene 428 by voice only (as indicated by the “-v”). As illustrated below, these features may be cross referenced by a system to identify particular scenes to include in a custom preview for a particular user that may be interested in the contents of one or more of the scenes (or selected portions thereof). Depending on the system configuration, the metadata library may also break down scenes with considerable more detail than illustrated in FIG. 4, such as tracking information like camera angles, cuts, lighting, props, costumes, background, etc.

The set of information regarding preferences of individual users, also referred to as the user preference library, may store preference information for individual users. The preference information may be stored in multiple user profiles, with each profile associated with a particular user. The user profiles may include various types of information about a user's feature preferences such as favorite actors, directors, writers, genres, themes, settings, music, or the like. While such preferences may be explicitly indicated by a user, such as by a user completing a form as to his/her preferences, the user profile may also be populated by tracking a user's content viewing habits and extrapolating preferences from those habits. For example, if a user has purchased, rented, or otherwise watched multiple programs with a particular actor, that actor may be associated with the user in the user's profile as a potential favorite actor. The same may apply to movies involving certain themes, locations, etc.

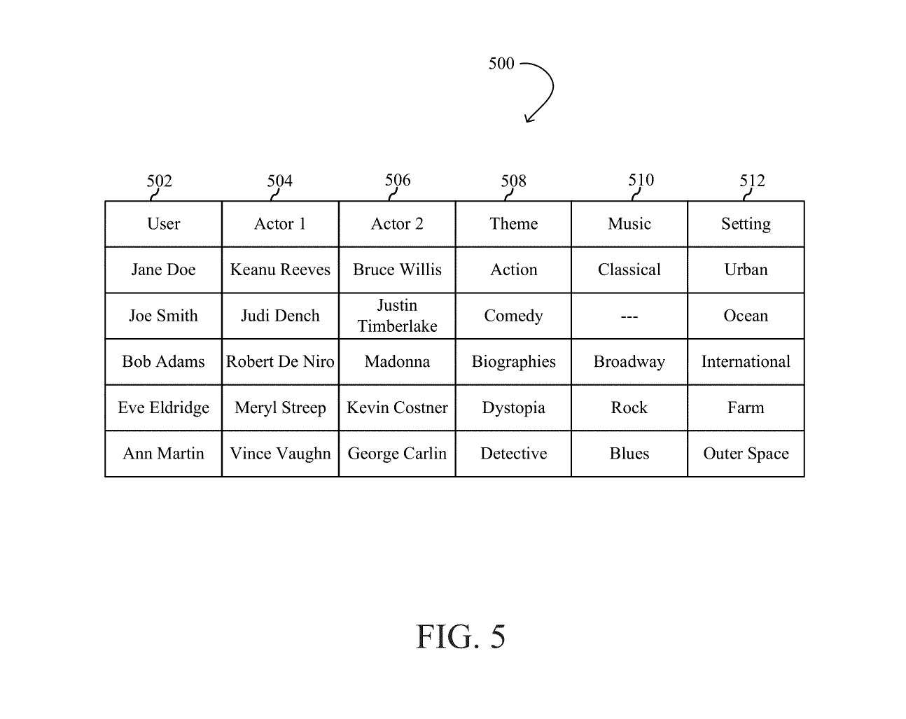

An example of user profiles is shown in FIG. 5. The table 500 shows a series of user profiles and certain program features that are preferred by the illustrated users. As with the metadata shown in FIG. 4, the table of FIG. 5 is merely an example, and user profiles and stored preferred program features may be implemented in a number of different ways. As shown, the table 500 includes one column 502 identifying the users and five columns identifying preferred program features associated with the particular users. Those columns include actor 1 504, actor 2 506, theme 508, music 510, and setting 512. Many other different categories of program features may also be used. Further, not each program feature may be associated with each user, as illustrated by the second user's lack of a music preference.

In another example, user preferences may be weighted or scored so that a system may track user preferences and possibly compare them to one another. Such scoring is not illustrated in FIG. 5. In one example, a user preferences may be rated. Those ratings may be explicitly indicated by a user, implied by the system based on user behavior, or created from a combination of explicit and implicit ratings indicators. For example, if a user has indicated a rating for certain programs (such as giving certain programs 5 stars while giving others 1 star), those ratings may affect whether certain content preferences are associated with a user. In one version of a user preference profile, program features may be scored based on a user's average ratings associated with the specific program feature. For example, if a user has watched three movies starring Keanu Reeves and given one movie 5 stars, one movie 4 stars, and another movie 3 stars, Keanu Reeves may be given a 4 star rating for the particular user. In another example, frequency of viewing may impact the weight or score of particular features associated with a user profile.

In another example, feature categories may have weights or scores such that for a particular user where specific actors are most important, actor preferences may have a higher weight than other feature categories. For a different user who cares more about themes, the theme of a program scene may be more important than the actors, so that user's profile may more heavily weight themes over other feature categories.

In another example a user profile may include a category associated with the user such as “teenage male.” Particular program features associated with the user's category may also be used to customize previews. Such more general category information may be especially useful for users without robust information in their user profile. Such categories may be based on the user's age, gender, occupation, geographic location, hobby, or other category to which the user may belong. Each category may have its own preference profile that may be cross referenced when creating a preview for a user which may be associated with the category in question. Each category may also have certain preference rules associated with the categories such that the preference rules may be applied to users belonging to the particular category. Machine learning techniques may also be applied to generate such preference rules based on behavior of users belonging to individual categories (i.e., determining what program features are in the programs viewed by users in particular categories.) Other information, such as social media rankings, group affinities of a user, etc. may also be used to associate specific features with a user as a member of a group that may appreciate one or more specific features.

Such categories may be useful when a new user without indicated preferences uses the system. Based on characteristics of the user (age, gender, occupation, geographic location, etc.), a system classifier may assign a category to the user and/or apply techniques such as machine learning to interpolate what preferences the user may have based on his/her characteristics or category rather than specific preferences indicated in the user's user profile.

In another example, user behavior that does not necessarily involve program viewing may impact a user preference profile and the scores of features in the profile. Thus, if a user exhibits an affinity for a particular feature in another context, such as shopping or web browsing, that affinity may be indicated in the user preference profile. For example, if a user purchases posters featuring a particular actor in a manner that the purchase may be associated with the user (such as an online purchase) that purchase may be considered by the system and the particular actor included in the user's preference profile, or the score associated with that actor in the user's profile increased. In another example, if a user repeatedly visits travel websites relating to a particular location, that location may be included in a user preference profile, or its weight adjusted to reflect the user's interest. A user profile may thus be dynamically updated by the system to reflect a user's current affinity for certain features, such as a rising interest in a particular actor, location, genre, etc. Other user behavior may also be considered when constructing and/or modifying a user profile.

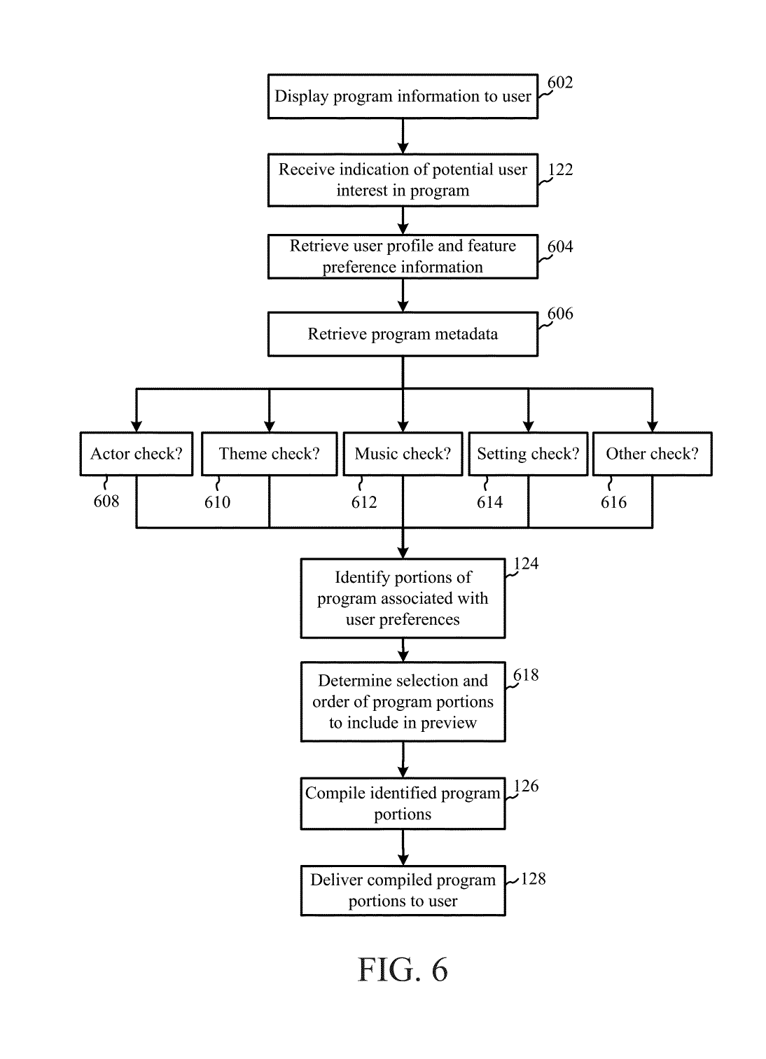

Using the information stored in a metadata library and a user profile library, a program delivery system may create custom previews for particular users as discussed below. As shown in block 602 of FIG. 6, a system displays program information to a user. This program information may take the form of a video-on-demand interface, application displaying available programming, web page, or the like. The program information may be communicated to a user through a computer, tablet, television set-top-box, or other device. The program information may include a synopsis of the program, images from the program, actors featured in the program, etc. The user may then indicate a desire to learn more about the program through a customized preview. That indication may be sent by pressing a button on a remote control, moving a cursor over a designated screen space on a display, or otherwise. The indication is then received by the system, as shown in block 122 of FIG. 6. Referring to the example of fictional Program 12345 of FIG. 4, the user may see an image of Program 12345 among many others in a video-on-demand catalog and may scroll a cursor over the image of the program. This may then result in a customized preview being dynamically created and displayed as follows.

Referring again to FIG. 6, the system retrieves the user profile and feature preference information, as shown in block 604. The user profile and feature preference information may be taken from a central location of user data, from a user device, from a location within the system, or from a different location. The system also retrieves metadata related to the program selected by the user (for example, Program 12345), as shown in block 606. The system then cross references the metadata and user preference information to identify where in the program particular features of interest to the user may be located, as shown in block 124. For example, the system may check for desired actors (608), themes (610), music (612), settings (614) or other features (616) indicated in the user profile. The system may also check for negative user preferences, such as an indication in the user profile that the user dislikes certain features (such as certain actors or themes) and may tag portions of the program which are associated with content reflecting the negative user preferences. Such disliked features may be indicated by a low or negative weight or score in the user profile.

Based on the user preferences and the identified portions of the program which are associated with the user preferences, the system may select and order the program portions to include in a preview to be displayed to the user, as shown in block 618. The selection and ordering process may depend on a number of factors. Program portions, such as scenes, may be selected based on user preferences, the weight associated with those preferences, negative preferences, or other information included in the user profile. For example, the system may select program scenes which include the highest weighted user preferred features but may also avoid certain content due to spoilers, age inappropriate material, etc. During this process the system may determine a user preference score for each scene based on each scene's inclusion of features preferred by the user. The system may then order the scenes in terms of score, reflecting an order of scenes that may appeal to the particular user. The system may then select from among the higher scoring scenes to compile the customized preview.

The system may also select scenes that have a flow to create a preview which makes logical sense to a user. To do so the system may rely on metadata for the scenes to select and order scenes that generally match in tone, dialog, and/or other factors. The system may also select scenes to match a certain length of the preview, for example to match an existing music track of a certain length, or to match a desired length that corresponds to other system constraints (such as bandwidth, etc.). Machine learning or other techniques may be used to match features of specific scenes (including dialogue, subtitles, etc.) to select and order scenes which create a logical intelligible preview.

The preview may be assembled at a server and then sent to a user. The system may also generate the preview by sending selected scenes in the determined order directly from the multimedia content library 222 to a user device without necessarily compiling the entire preview before sending.

In one aspect the system may take an existing preview for a program (such as a theatrical release trailer) and reorder the scenes of the existing preview to match a user's desired features. For example, if an existing preview for a movie includes a user's favorite actor, but not until the end of the existing preview, the user may stop watching the preview and move on to consider another movie before realizing the first movie starred the favorite actor. The system may correct this problem by re-ordering the scenes to feature the favorite actor early in the preview so that the user quickly realizes the movie includes the favorite actor. In another aspect the system may create a customized preview of a program using only portions of the existing preview supplemented with other content from the program identified through the methods discussed. In another aspect the system may simply create a customized preview for a user without referencing an existing preview.

Continuing with the example of Program 12345, if user Jane Doe as shown in FIG. 5 indicates a desire to learn more about Program 12345, the system may create a customized preview for her with scenes from Program 12345 that include features she prefers, such as scenes with Keanu Reeves or Classical music (i.e., scenes 424, 426, or 428). Depending on the weighting of her preferences, however, the system may determine that the scene featuring Keanu Reeves working at a computer may (424) may be too uninteresting in terms of content (particularly as Jane Doe likes action themes) and may skip that scene. Further, Jane Doe's user preferences may indicate a strong dislike for Kevin Costner, and thus the system may not include scene 426 in a customized preview for Jane Doe. If the system were to create a customized preview for Program 12345 for user Eve Eldridge, it may select scenes 426, 428, and/or 430 based on her actor preferences. For user Ann Martin the system may select scene 430 as the scene involves science investigation in an outer space laboratory and Eve Eldridge has a preference for detective themes and outer space settings. For users Joe Smith and Bob Adams, who in the selected example have no overlapping preferred features with the first few scenes of Program 12345, other scenes may include desired features. Or the system may choose scenes for those users based on features which may appeal to other users in categories shared by Joe Smith and Bob Adams.

For each user the system may create a customized preview entirely from scenes which feature user preferred features or may combine scenes with user preferred features with other scenes in order to create a logical preview. The scenes with user preferred features may be placed in prominent positions during the preview, such as at the beginning or during featured portions of music, in order to highlight the desired features to the user.

Although the descriptions above have focused on combining scenes together for a customized preview the system may also overlay specific audio, such as a music track, to coincide with a user's preference. For example, if a program features different musical selections, the system may choose to overlay the custom preview with a musical selection that matches the user's preferred musical features.

In another aspect, the system may not generate a specific preview for a user, but rather may select one of several pre-configured previews for a program based on which of the pre-configured previews most closely aligns with the user's category, characteristics, preferred program features, etc. The preview may be selected based on a score of the preview for the particular user based on the factors discussed above.

In another aspect, the system may generate previews for other content types, such as audio, books, or video games. For other forms of content, previews may be created in a similar manner as described above, such as by creating a preview of the content by highlighting content features (which are akin to program features) that appeal to the user. For a musical or audio work content features may include tone, tempo, octave, music category, theme, or other audio features. Previews may also be created for other content types, such as books or other written content. For a written work, content features may include such features as dialogue, theme, characters, tone, etc. The preview of a written work may be displayed to a user, sent to a user or even read to a user using text-to-speech techniques.

As discussed above, the various embodiments may be implemented in a wide variety of operating environments, which in some cases can include one or more user computers, computing devices, or processing devices which can be used to operate any of a number of applications. Local and remote devices can include any of a number of general purpose personal computers, such as desktop or laptop computers running a standard operating system, as well as cellular, wireless, and handheld devices running mobile software and capable of supporting a number of networking and protocols. Such a system also may include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as may be part of a service-oriented architecture. Services such as Web services can communicate using any appropriate type of communication, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS and CIFS. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java, C, C# or C++, or any scripting language, such as Perl, Python, or TCL, as well as combinations thereof. The server(s) may also include database servers, including without limitation those commercially available from Oracle, Microsoft, Sybase, and IBM.

The environment may include a variety of data stores and other memory and storage media as discussed above. These may reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, keypad, or microphone), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the system or device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. A computer-implemented method for creating a customized preview for a program, the method comprising:
receiving an indication to display a preview of a program for a user;
identifying a preexisting preview of the program;
identifying a plurality of actors appearing in the preexisting preview;
selecting an actor of the plurality of actors based at least in part on user information;
identifying at least one portion in the preexisting preview including the selected actor;
creating a new preview with the at least one portion moved to earlier in the new preview than in the preexisting preview; and
delivering the new preview to the user.

2. The computer-implemented method of claim 1, wherein selecting the actor comprises:
determining a score for each actor of the plurality of actors, wherein each score is based at least in part on the user information; and
selecting the actor from the plurality of actors based on a score of the selected actor.

3. The computer-implemented method of claim 1, further comprising:
identifying a second actor based at least in part on the user information, wherein the second actor does not appear in the preexisting preview;
identifying a portion of the program including the second actor wherein the portion does not appear in the preexisting preview; and
including the portion in the new preview.

4. The computer-implemented method of claim 1, further comprising:
identifying a second actor based at least in part on the user information; and
identifying a portion in the preexisting preview including the second actor, and
wherein creating the new preview comprises creating the new preview without the portion including the second actor.

5. A computer-implemented method comprising:
obtaining one or more program features associated with a user;
obtaining information about a program;
selecting a plurality of portions of the program, based at least in part on the one or more program features associated with the user; and
ordering the plurality of portions of the program into a sequence of program portions.

6. The computer-implemented method of claim 5, wherein the one or more program features comprise at least one of an actor, genre, music, location, theme, or age-appropriate content.

7. The computer-implemented method of claim 5, wherein the sequence of program portions includes at least one program portion that does not include a program feature associated with the user.

8. The computer-implemented method of claim 5, wherein the ordering is based on a score of the one or more program features associated with the user.

9. The computer-implemented method of claim 8, wherein a first portion of the program including with a first score is located earlier in the sequence of program portions than a second portion of the program with a second score, wherein the first score is higher than the second score.

10. The computer-implemented method of claim 8, further comprising:
determining at least one program feature with a score below a threshold;
identifying a portion of the program including the at least one program feature with the score below the threshold; and
omitting the portion of the program including the at least one program feature with the score below the threshold from the sequence of program portions.

11. The computer-implemented method of claim 5, further comprising delivering the sequence of program portions to a device associated with the user.

12. The computer-implemented method of claim 5, wherein the sequence of program portions includes at least one program portion selected from a preexisting preview of the program.

13. A system for confirming a delivery location, comprising:
at least one processor; and
a memory device including instructions operable to be executed by the at least one processor to perform a set of actions, configuring the processor:
obtaining one or more content features associated with a user;
obtaining information about a content item;
selecting a plurality of portions of the content item, based at least in part on the one or more content features associated with the user; and
ordering the plurality of portions of the content item into a sequence of content portions.

14. The system of claim 13, wherein the content comprises a program and the content features comprise at least one of an actor, genre, music, location, or theme.

15. The system of claim 13, wherein the content item comprises an audio work and the content features comprise at least one of tone, tempo, octave, music category, or theme.

16. The system of claim 13, wherein the sequence of content portions includes at least one content portion that does not include a content feature associated with the user.

17. The system of claim 13, wherein the at least one processor is further configured to order based on a score of the one or more content features associated with the user.

18. The system of claim 17, wherein a first portion of the content item including with a first score is located earlier in the sequence of content portions than a second portion of the content item with a second score, wherein the first score is higher than the second score.

19. The system of claim 17, wherein the at least one processor is further configured:
to determine at least one content feature with a score below a threshold;
to identify a portion of the content including the at least one content feature with the score below the threshold; and
to omit the portion of the content including the at least one content feature with the score below the threshold from the sequence of content portions.

20. The system of claim 13, wherein the at least one processor is further configured to deliver the sequence of content portions to a device associated with the user.

21. The system of claim 13, wherein the sequence of content portions includes at least one content portion selected from a preexisting preview of the content.
